(19) United States
(12) Patent Application Publication
(10) Pub. No.: US 2026/0246060 A1
(43) Pub. Date: Aug. 20, 2026

(54) BATTERY SUBPACK THERMAL RUNAWAY CONTAINMENT

(71) Applicant: BETA AIR LLC, South Burlington, VT (US)

(72) Inventors: Nathan Goldsberry, Winooski, VT (US); Michael Cemprola, Charlotte, VT (US); Yesaswi Chilamkurti, Williston, VT (US); Sam Wagner, Westford, VT (US)

(21) Appl. No.: 19/058,353

(22) Filed: Feb. 20, 2025

(51) Int. Cl. H01M 50/342; H01M 50/213; H01M 50/224; H01M 50/231; H01M 50/296; H01M 50/30

(52) U.S. Cl. CPC H01M 50/3425; H01M 50/213; H01M 50/224; H01M 50/231; H01M 50/296; H01M 50/394

(57) ABSTRACT

A subpack enclosure is a pressure vessel controlling cell thermal runaway products with a metallic layer, thermal insulation, and a flame liner between side walls and cell vents. Optional crush and blast ablative layers can absorb thermal runaway ejecta energy. A vent gap directs ejecta to a headspace and a front end burst plate that ruptures at a threshold pressure. A capture plate retains the burst plate against a support plate of the front end wall. Back end passthrough assemblies include mating parts engaging inner and outer surfaces of the end wall, sealing passthrough cutouts and can include gaskets.

### BACKGROUND OF THE INVENTION

The disclosure relates generally to electric vehicle safety measures, and more particularly to battery cell thermal runaway safety measures in battery subpacks.

In electric vehicle batteries, measures are provided to control the effects of thermal runaway of one or more cells. In ground-and water-based vehicles, thermal insulation of various types can be included with little consideration of the weight of such materials. However, weight is a significant consideration for electric aircraft.

### BRIEF DESCRIPTION OF THE INVENTION

All aspects, examples and features mentioned below can be combined in any technically possible way.

An aspect of the disclosure provides a battery subpack comprising: a subpack enclosure including a front end and a back end opposite the front end, wherein the subpack enclosure is sealed as a pressure vessel and the front end includes a burst plate configured to rupture when a parameter of an interior of the subpack enclosure exceeds a threshold value; and a cell group including a front end, a back end, and a vent side, wherein the cell group is disposed in the subpack enclosure with the respective front ends and back ends of the cell group and the subpack enclosure proximate to each other.

Another aspect of the disclosure includes any of the preceding aspects, and wherein at least one wall of the subpack enclosure includes an outer layer of a metallic material, a layer of thermal insulation between the outer layer and the cell group, and a flame liner between the layer of thermal insulation and the cell group.

Another aspect of the disclosure includes any of the preceding aspects, and wherein the subpack enclosure further includes a layer of electrical insulation between the flame liner and the cell group.

Another aspect of the disclosure includes any of the preceding aspects, and wherein the subpack enclosure further includes a crush layer between a first side wall of the subpack enclosure and the cell group.

Another aspect of the disclosure includes any of the preceding aspects, and wherein the subpack enclosure further includes a blast ablative layer between the crush layer and the cell group.

Another aspect of the disclosure includes any of the preceding aspects, and wherein a vent gap is defined by the vent side of the cell group and an innermost layer of the first side wall of the subpack enclosure.

Another aspect of the disclosure includes any of the preceding aspects, and wherein respective bases of cells of the cell group are mounted on a surface of a heat exchange device with respective vent ends of the cells directed at the first side wall of the subpack enclosure such that ejecta from one of the cells during a thermal runaway state thereof enters the vent gap.

Another aspect of the disclosure includes any of the preceding aspects, and wherein the cell group includes a current collector between the vent ends of the cells and the first side wall of the subpack enclosure, and wherein the current collector includes a respective hole aligned with each respective vent end of the cells.

Another aspect of the disclosure includes any of the preceding aspects, and wherein the vent gap is in fluid communication with a headspace defined between a top of the cell group and a top wall of the subpack enclosure, wherein the vent gap is positioned to direct ejecta from the cell group to the headspace.

Another aspect of the disclosure includes any of the preceding aspects, and wherein the headspace is in fluid communication with the burst plate.

Another aspect of the disclosure includes any of the preceding aspects, and wherein a vent clearing bracket engages and retains the front end of the cell group in position.

Another aspect of the disclosure includes any of the preceding aspects, and wherein a front end wall of the subpack enclosure includes an opening therethrough and a spar extending across the opening, the burst plate engages an outer side of the spar, and a capture plate engages an outer surface of the burst plate to retain the burst plate against the spar, thereby sealing the subpack enclosure Another aspect of the disclosure includes any of the preceding aspects, and wherein the burst plate includes an intumescent material.

Another aspect of the disclosure includes any of the preceding aspects, and further comprising a headspace between a top of the cell group and the top wall of the subpack enclosure.

An aspect of the disclosure provides a subpack electrical terminal assembly for the battery subpack, further comprising: a back plate on an inner surface of a back end wall of the subpack enclosure; a terminal connector extending from the back plate toward the cell group and in electrical communication with a conductive layer of a current collector of the battery subpack, wherein the terminal connector includes a hole shaped and sized to receive a post of a connector cable, and wherein the back plate includes an opening therethrough to allow passage of such posts; and a front plate on an outer surface of the back end wall and secured to at least one of the back end wall, the back plate, or the terminal connector by bolts extending therethrough with nuts thereon.

Another aspect of the disclosure includes any of the preceding aspects, and wherein the front plate has an opening formed therein to allow connection to the terminal connector.

Another aspect of the disclosure includes any of the preceding aspects, and wherein the respective openings of the back plate and the front plate correspond to each other.

Another aspect of the disclosure includes any of the preceding aspects, and wherein one of the back plate or the front plate includes a projection and the other of the back plate or the front plate includes a recess corresponding to the projection, wherein the projection and recess mate and form a seal.

Another aspect of the disclosure includes any of the preceding aspects, and further comprising a gasket.

Another aspect of the disclosure includes any of the preceding aspects, and wherein the gasket is formed from a material including mica.

Another aspect of the disclosure includes any of the preceding aspects, and wherein the gasket is between the terminal connector and the back plate.

Another aspect of the disclosure includes any of the preceding aspects, and wherein the gasket is between the back plate and the front plate.

Another aspect of the disclosure includes any of the preceding aspects, and wherein at least one of the back plate or the front plate includes a ceramic material.

An aspect of the disclosure provides a data passthrough assembly for the battery subpack of claim 1, comprising: a data cutout formed through the back end wall; a circuit board disposed at an inner surface of the back end wall, wherein the circuit board is held in position by the current collector and includes receptacles; and a data connector including a base disposed in the data cutout, wherein the base includes pins that extend from the base toward the circuit board and into the receptacles, wherein the data connector further includes a body that extends away from the data cutout and includes conductors and features sized and shaped to correspond to a data cable connector.

Another aspect of the disclosure includes any of the preceding aspects, and further comprising a data gasket between the circuit board and the back end wall.

Another aspect of the disclosure includes any of the preceding aspects, and wherein the gasket includes mica.

Another aspect of the disclosure includes any of the preceding aspects, and wherein the pins include copper.

Another aspect of the disclosure includes any of the preceding aspects, and wherein the data connector includes ceramic materials and copper.

Another aspect of the disclosure includes any of the preceding aspects, and wherein the circuit board includes a flame retardant glass-reinforced epoxy laminate material with a National Electrical Manufacturers Association (“NEMA”) grade of at least FR-4.

Another aspect of the disclosure includes any of the preceding aspects, and wherein the data connector includes an additional material inboard of the pins.

Another aspect of the disclosure includes any of the preceding aspects, and wherein the additional material includes silicone.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an elevation of a battery subpack and showing a front end thereof according to aspects of the disclosure;

FIG. 2 shows an elevation of a battery subpack and showing a back end thereof according to aspects of the disclosure;

FIG. 3 shows a schematic elevation of a cell used in a battery subpack according to aspects of the disclosure;

FIG. 4 shows an elevation of cells of a battery subpack according to aspects of the disclosure as seen in FIG. 1 with the subpack enclosure and other components removed;

FIG. 5 shows an elevation of a battery subpack according to aspects of the disclosure as seen in FIG. 2 with the subpack enclosure removed to show a current collector and other components of the battery subpack;

FIG. 6 is cross section across a longitudinal axis of a battery subpack according to aspects of the disclosure looking toward the back end thereof;

FIG. 7 is a schematic view of the cross section of the example of a battery subpack shown in FIG. 6;

FIG. 8 is a partial cross-sectional view of battery subpacks according to aspects of the disclosure;

FIG. 9 is shows a front end of a battery subpack and a schematic exploded view of a front wall and burst plate assembly of a battery subpack according to aspects of the disclosure;

FIG. 10 is an elevation of a back end of a battery subpack according to aspects of the disclosure;

FIG. 11 is a close up cross section of the elevation shown in FIG. 10 centered on a terminal assembly thereof according to aspects of the disclosure; and

FIG. 12 is a close up cross section of the elevation shown in FIG. 10 centered on a data connector assembly thereof according to aspects of the disclosure.

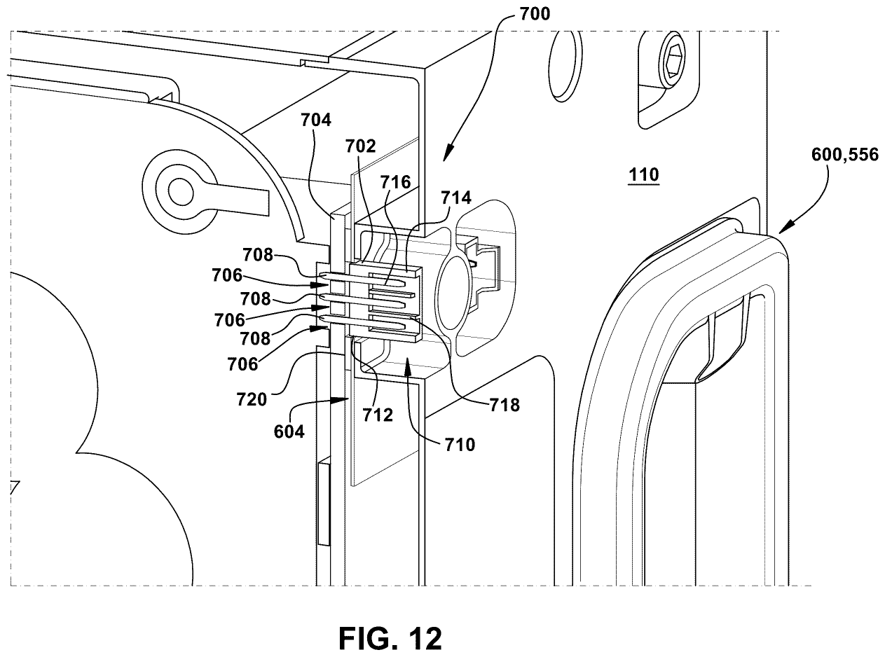

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a battery subpack and cell array therefor. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part. It should be understood that embodiments disclosed herein may be described in the context of and or implementation in electric aircraft, but could also be implemented in other electric vehicles as suitable and/or desired. That said, embodiments as disclosed herein include features that can particularly enhance desirability for use in aircraft, such as the use of alternative materials, structures, and/or methods resulting in reduced vehicle weight and/or enhanced aircraft safety.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as a coolant employed during operation of an electric vehicle using embodiments of the disclosure or, for example, the flow of air through and/or around an electric vehicle, such as an electric aircraft, in which embodiments of the disclosure are deployed. The term “downstream” corresponds to the direction of flow of the fluid, and the term “upstream” refers to the direction opposite to the flow. The terms “forward” and “aft,” without any further specificity, refer to directions, with “forward” or “fore” referring to the front or nose of an electric aircraft, and “aftward” or “aft” referring to the rearward or tail end of the aircraft.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. In addition, several descriptive terms may be used regularly herein, as described below. The terms “first,” “second,” and “third,” may be used interchangeably to distinguish one component from another and are not intended to signify location or importance of the individual components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present and that the description includes instances where the event occurs or the component is present and instances where the event does not occur or the component is not present.

Where an element or layer is referred to as being “on,” “engaged to,” “engaging,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly engaging,” “directly connected to,” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple,” “connect,” “attach,” and “mount” may be used interchangeably herein.

Aspects of the invention provide a battery subpack with a subpack enclosure that is a pressure vessel with a burst plate to contain products of thermal runaway until a threshold parameter value, such as pressure, is reached within the subpack enclosure. The burst plate acts as a vent or relief valve, allowing material from within the subpack enclosure to escape when the threshold parameter value is exceeded. The subpack enclosure includes an outer metallic layer surrounding battery cell groups that are arranged with vents of the cells directed at side walls of the subpack enclosure. All walls of the subpack enclosure can include thermal insulation, a flame liner, and/or electrical insulation between the outer metallic layer and the cell groups. A current collector can also overlie the cells between the cell vents and the innermost layer of the respective side wall. Additional thermal insulation can be included between the cell groups and the top and bottom walls of the subpack enclosure. The side walls can include a crush layer and a blast ablative layer, where the innermost layer of each side wall and the vent side of each cell group define a vent gap.

During thermal runaway of a cell, hot gas, liquid, particles, and or other material (collectively, “ejecta’) can exit the cell. Consequently, during thermal runaway of one or more cells, ejecta from the cell(s) exits the cell group toward the blast ablative layer, passing through ejecta handling measures of the current collector, and travels along the vent side of the cell group and the side wall to a headspace defined between the top of the cell group and the top wall of the subpack enclosure. The headspace directs ejecta toward a front end of the subpack, where the front end wall includes the burst plate. A vent clearing bracket at the front end of the subpack enclosure engages the cell group front end to secure the cell group in position, preventing exit of the cell group from the subpack enclosure when the burst plate opens.

The front end wall includes a hole with spars extending across the hole, and the burst plate is retained over the hole and against the spars. A burst gasket or the like engages the outer side of the burst plate to hold it over the hole and against spars of the front end wall of the subpack enclosure. Thus, the burst plate seals the front end while the spars prevent the burst plate from deflecting into the subpack enclosure. The burst plate is shaped, sized, and made of a suitable material such that when the threshold pressure is exceeded, at least a portion of the burst plate deflects outward, away from the spars, to release thermal runaway products (ejecta from one or more cells) in a directed manner. If desired and/or suitable, the burst plate can be weakened in addition to or instead of using size, shape, and material selection, such as by scoring with one or more grooves, so that the burst plate will rupture when the threshold pressure in the subpack enclosure is reached or exceeded.

The subpack enclosure protects electrical and data connections from ejecta by placing the connections at the back end of the subpack enclosure, thereby separating them from the front end. The connections are also protected from fluid leakage, such as from liquids used for heat transfer in the battery subpack, by placing fluid connectors at the front end of the subpack enclosure. The electrical and data connections include passthrough assemblies that maintain the seal of the subpack enclosure. Data passthrough assemblies include circuit boards and/or other layers made from a flame retardant glass-reinforced epoxy laminate material, such as a flame retardant glass-reinforced epoxy laminate material. Particularly within the subpack enclosure, a preferred material has a National Electrical Manufacturers Association (“NEMA”) grade of at least FR-4. Such material is generally referred to in the art simply as “FR-4” or “FR4,” where “FR” stands for “flame retardant.” As is known, NEMA sets standards for various materials and components. FR-4 is a composite material composed of, for example, woven fiberglass cloth with an epoxy resin binder that is flame resistant.

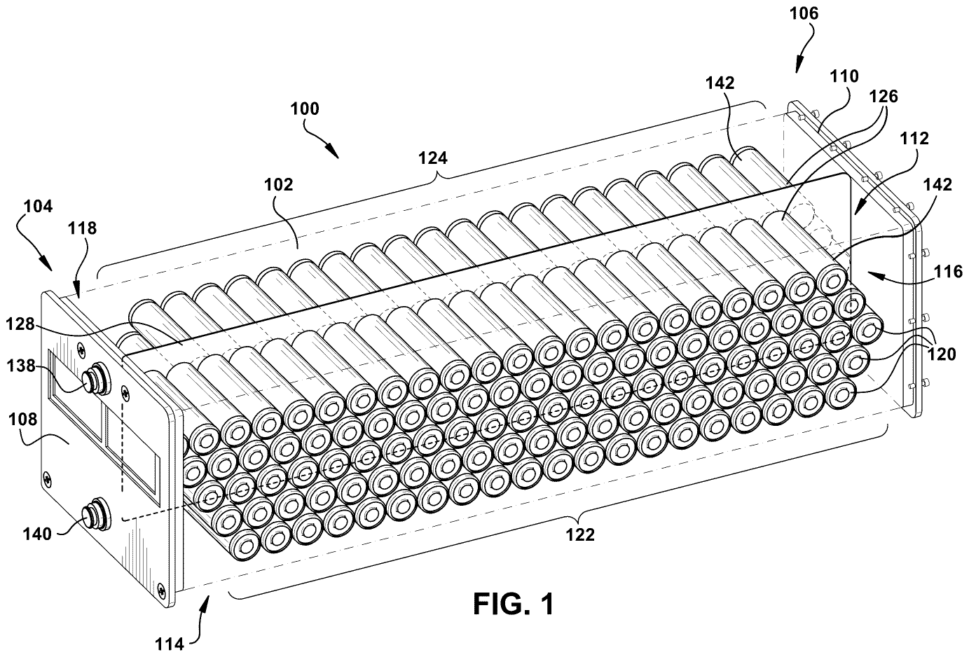

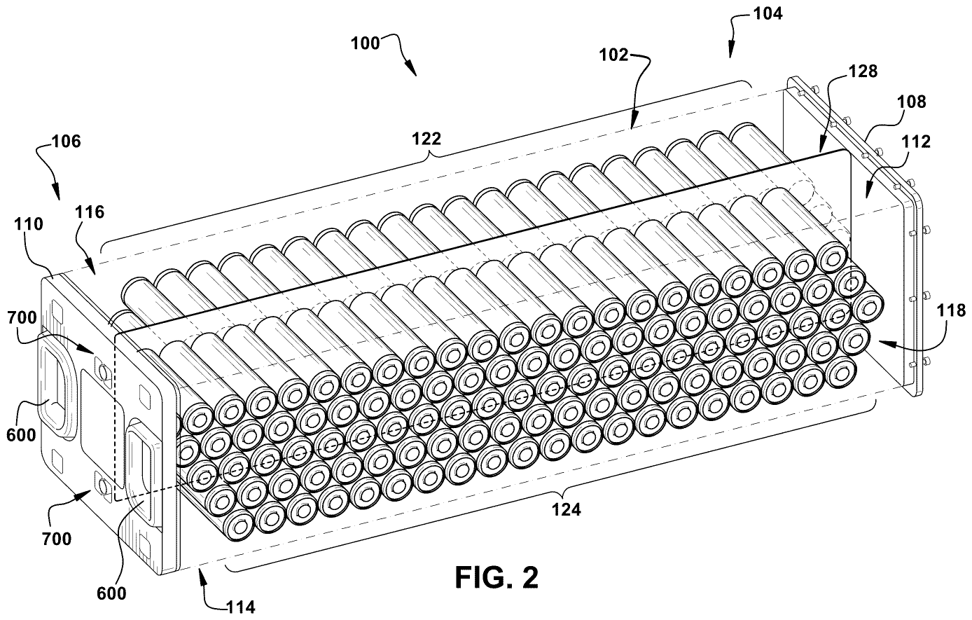

FIGS. 1 and 2 show front and back end elevations of an example of a battery subpack 100 including aspects of the invention. Battery subpack 100 can include a subpack enclosure 102 having a front end 104 and a back end 106. Subpack enclosure 102 can include a front end wall 108, a back end wall 110, a top wall 112, a bottom wall 114, a first side wall 116, and a second side wall 118 opposite first side wall 116. Battery cells 120 are disposed within subpack enclosure 102, such as in a first cell group 122 and a second cell group 124. As seen in FIG. 1, bases 126 of cells 120 in first cell group 122 face bases 126 of cells 120 in second cell group 124. As a result of close packing, cells 120 appear in a hexagonal arrangement of cells 120 according to embodiments of the disclosure can be seen in both cell groups 122, 124 in FIGS. 1 and 2. In other embodiments, such packing and such a pattern need not be employed. As particularly seen in FIG. 2, back wall 110 can include electrical connector assemblies 600 and data connector assemblies 700, as will be described hereinafter.

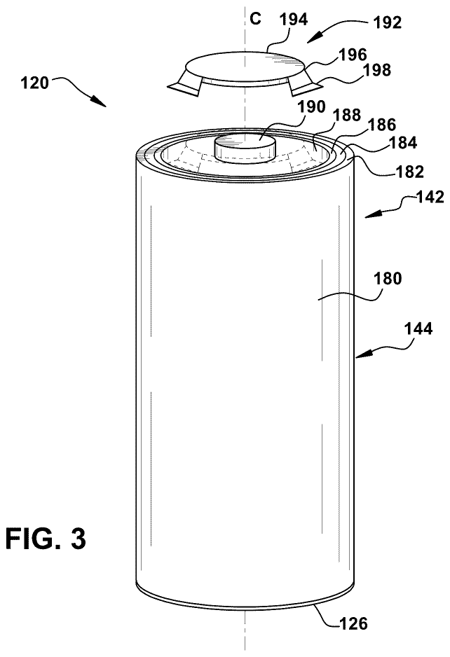

FIG. 3 shows an example of a cell 120 that can be used in embodiments of the disclosure. Cell 120 includes base 126 and a vent end 142 opposite base 126 with a body 180 extending therebetween. Body 180 has an outer surface 144, and vent end 142 includes an insulative jacket 182, an anode 184, an insulative layer 186, a vent 188, and a cathode 190. As seen in FIG. 1, cell 120 has a central axis C extending longitudinally and with which all components of cell 120 are aligned. As is known in the art, an electrolyte is disposed within body 180 of cell 120 such that ions are exchanged between anode 184 and cathode 190 to produce electric potential and/or current therebetween. A cap 192 covers cathode 190 and includes a contact 194 made from a conductive material and which can be a disc. Contact 194 is supported by legs 196 that include feet 198. Cap 192 is shown above its operative position, which is shown in dashed lines where feet 198 rest on vent 188 and engage insulative layer 186. It should be noted that while cell 120 is illustrated as cylindrical, which is preferred, cells of other shapes could be employed within the scope of embodiments. Cell 120 can advantageously be rechargeable, particularly of the lithium ion type or the lithium metal type of rechargeable cell, as non-limiting examples. During operation, vent 188 can allow gas to escape cell 120, and during a thermal runaway event, vent 188 can allow ejecta, such as hot gas, liquid, particles, and other material, to escape cell 120. Cap 192 can be forced off vent end 142 during such a thermal runaway event by escaping ejecta, or ejecta can escape around cap 192, depending on the particular manner in which feet 198 are connected to vent end 142.

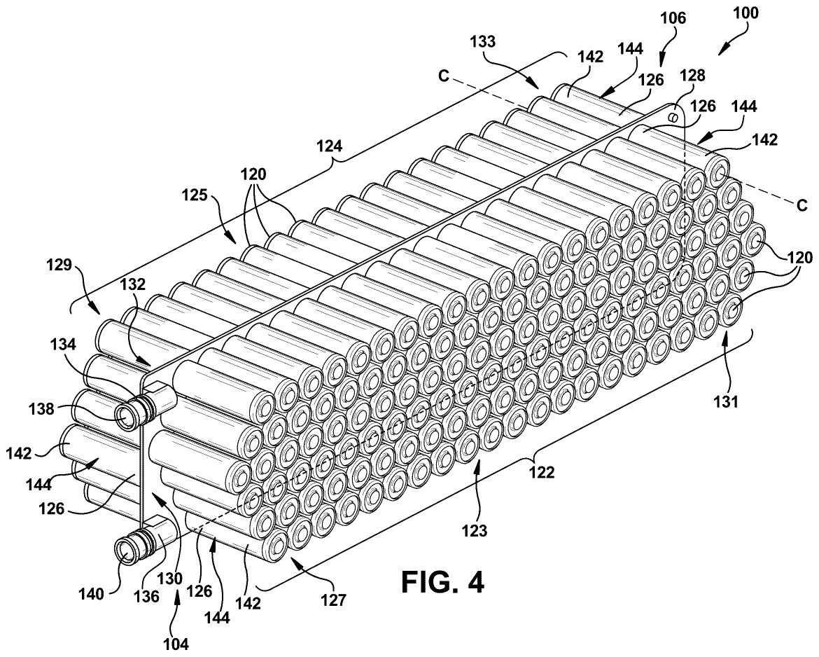

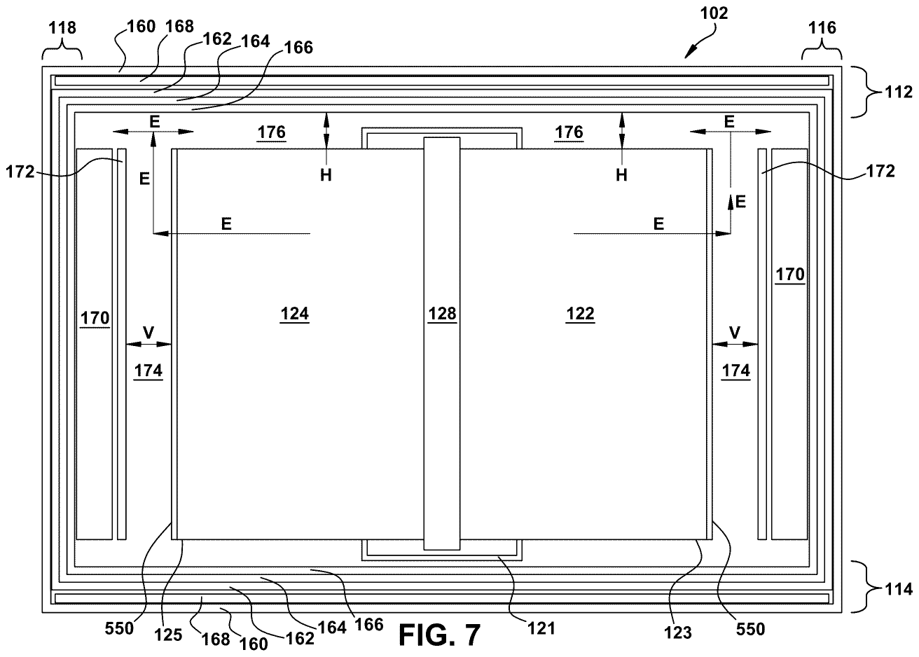

Turning now to FIG. 4, where subpack enclosure 102 is removed from battery subpack 100, bases 126 of cells 120 of each cell group 122, 124 can engage a respective opposed surface of a heat exchange device 128. In embodiments, a cell retainer 121 seen in cross section in FIG. 7 can surround at least a portion of cell groups 122, 124 to hold cells 120 in place against heat exchange device 128. Cell retainer 121 (FIG. 7) can surround at least a portion of both cell groups 122, 124, or each cell group 122, 124 can have a respective cell retainer 121 (FIG. 7), and in either case, cell retainer(s) 121 (FIG. 7) can also engage heat exchange device 128 if suitable and/or desired. Thus, in the example shown in FIG. 4, bases 126 of cells 120 in first cell group 122 can engage a first surface 130 of heat exchange device 128, and bases 126 of cells 120 in second cell group 124 can engage a second surface 132 of heat exchange device 128 that is opposite first surface 130 of heat exchange device 128. As a result, vent ends 142 of cells 120 in both cell groups 122, 124 are directed away from heat exchange device 128, forming respective vent sides 123, 125 of cell groups 122, 124. Cell groups 122, 124 also have respective front ends 127, 129 and back ends 131, 133.

In embodiments, heat exchange device 128 can include a fluid inlet 134 and a fluid outlet 136 to provide flow of a fluid through a fluid passage 136 between first surface 130 and second surface 132. Preferably, at least one of fluid inlet 134 and fluid outlet 136 is disposed at front end 104 of subpack enclosure 102. It can be advantageous in embodiments for both of fluid inlet 134 and fluid outlet 136 to be formed at front end 104 of subpack enclosure 102, in which case fluid inlet 134 and/or fluid outlet 136, and/or respective connectors 138, 140 therefor, can extend through front end wall 108 of subpack enclosure 102 (FIG. 1). In embodiments, heat exchange device 128 can be a cold plate through which a liquid coolant and/or air can circulate to exchange heat between cells 120 and a heat source and/or sink outside of battery subpack 100.

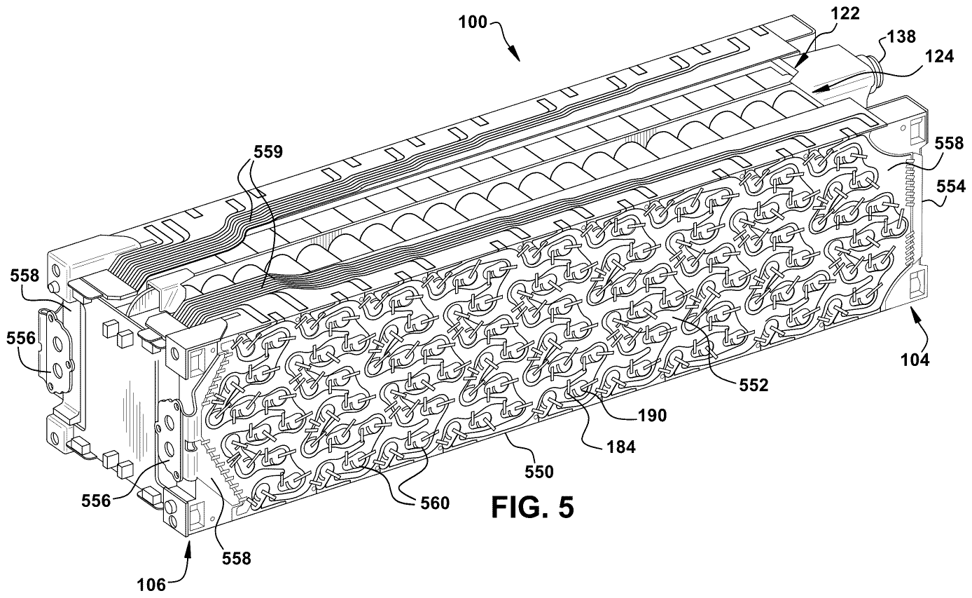

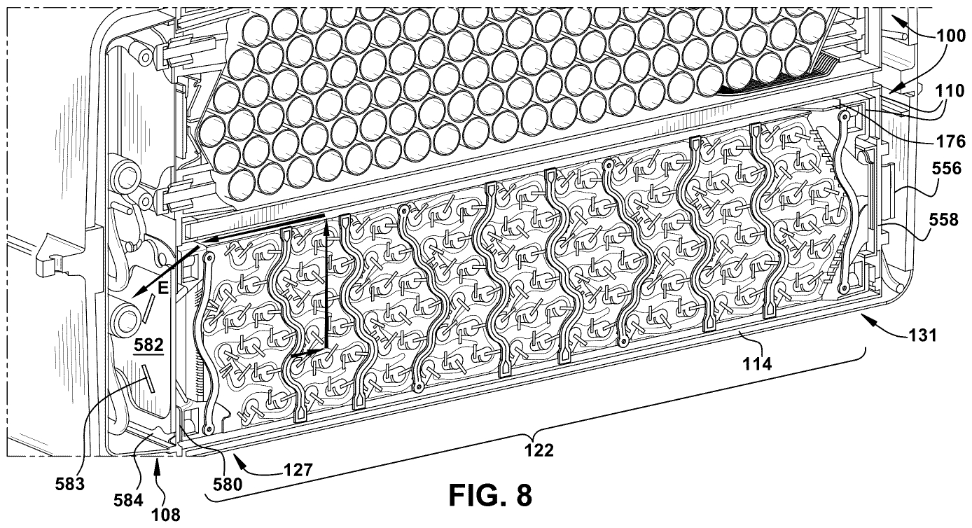

Turning now to FIG. 5, battery subpack 100 is shown in an elevation with subpack enclosure 102 removed and in which back end 106 is foremost. Each side of battery subpack 100 includes a current collector 550 along respective cell group 122, 124 and is connected thereto so as to achieve a desired voltage and/or current. Each current collector 550 is connected to a respective electrical terminal 556 at back end 106 of battery subpack 100 and to the other current collector 550 via a busbar 554 at front end 104 of battery subpack 100 in series. So connected, with a suitable connection pattern between cell groups 122, 124 and current collectors 550, one electrical terminal 556 is an anode of battery subpack 100 and the other electrical terminal 556 is a cathode of battery subpack 100. Current collector 550 can also include measurement leads 559 connected to data terminals 557 as will be described below. As seen in FIG. 5 with additional reference to FIG. 8, current collector 550 includes holes 560 aligned and sized to allow ejecta to pass through current collector 550 during a thermal runaway event. Ejecta can then be directed out of subpack enclosure 102. along (up) a respective side wall 116, 118 of subpack enclosure 102 to a headspace 176 (FIG. 4) between first cell group 122 and top wall 112 of subpack enclosure 102.

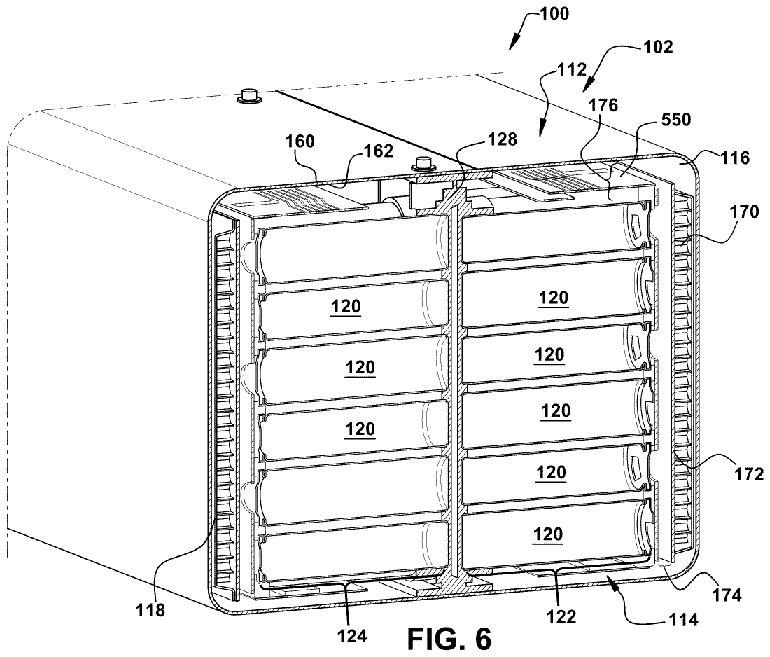

As noted above, embodiments can include measures to direct thermal runaway ejecta away from sensitive components of battery subpack 100. An example of an implementation of such measures is seen in the cross-sectional view of FIG. 6 and schematic cross-sectional view of FIG. 7. As seen in FIGS. 6 and 7, subpack enclosure 102 in embodiments can have top wall 112, bottom wall 114, first side wall 116, and second side wall 118 joined together and surrounding first and second cell groups 122, 124 attached to heat exchange device 128. Alternatively, two or more walls of subpack enclosure 102 can be formed as a single piece. With additional reference to FIG. 1, when front end wall 108 and back end wall 110 (FIG. 1) are sealed to respective ends of top wall 112, bottom wall 114, first side wall 116, and second side wall 118, subpack enclosure 102 is sealed as a pressure vessel. At least one wall of subpack enclosure 102 can include an outer layer 160, which can include a metallic material, such as titanium, where suitable and/or desired. Whatever materials are used, outer layer 160 should be sized and its materials selected to withstand design criteria, such as stress induced when pressure within subpack enclosure 102 exceeds a threshold value, such as a burst pressure as will be explained below.

To reduce a temperature of outer layer 160, a layer 162 of thermal insulation can be formed or disposed between outer layer 160 and each cell group 122, 124. A flame liner 164 can also be disposed between layer 162 of thermal insulation and each cell group 122, 124, such as to protect thermal insulation layer 162 from flames that might occur during a thermal runaway event. To reduce the likelihood of electrification of subpack enclosure 102, embodiments can include a layer 166 of electrical insulation between flame liner 164 and each cell group 122, 124. In particular implementations, top wall 112, bottom wall 114, and first and second side walls 116, 118 all include outer layer 160 of a metallic material, layer 162 of thermal insulation, flame liner 164, and layer 166 of electrical insulation. Top wall 112 and/or bottom wall 114 can include an additional insulation layer 168 between outer layer 160 and layer 162 of thermal insulation to further reduce a temperature of outer layer 160. With continuing reference to FIGS. 6 and 7, for additional thermal runaway protection, a crush layer 170 can be disposed between each cell group 122, 124 and a respective side wall 116, 118 to absorb energy of ejecta from one or more cells in a thermal runaway state. Crush layer 170 can include a metal foam or the like that will deform when subject to impact, such as when particles, debris, gases, and other materials expelled during a thermal runaway event strike crush layer 170. Further, subpack enclosure 102 can include a blast ablative layer 172 between crush layer 170 and each cell group 122, 124. Blast ablative layer 172 can include a material that erodes and/or ablates when exposed to ejecta E, which can reduce thermal and kinetic energy of ejecta E. Thus, during a thermal runaway event, ejecta E passing through current collector 550 can encounter blast ablative layer 172, which cools and/or slows ejecta E, and crush layer 170, which can deform when struck to reduce kinetic energy of ejecta E, as well as prevent deformation of layers of subpack enclosure 102 further outside of crush layer 170.

As seen particularly in FIG. 7, a vent gap 174 of size V is defined by the respective vent side 123, 125 of each cell group 122, 124 and an innermost layer of each respective side wall 116, 118, here shown as blast ablative layer 172. During a thermal runaway state of a cell, ejecta E from the cell enters vent gap 174 and can strike blast ablative layer 172 and/or crush layer 170 as noted above. Ejecta E is then redirected so that it travels through vent gap 174 along the vent side 123, 125 of the cell group 122, 124 and along the respective side wall 116, 118 to a headspace 176 of height H defined between the respective cell group 122, 124 and top wall 112. As seen in FIG. 8, headspace 176 is in fluid communication with front end wall 108 of subpack enclosure 102. Thus, vent gap 174 directs ejecta E from a cell 120 of cell group 122, 124 to headspace 176, which directs ejecta E to front end wall 108, which can include a burst plate assembly 580 retaining a burst plate 582.

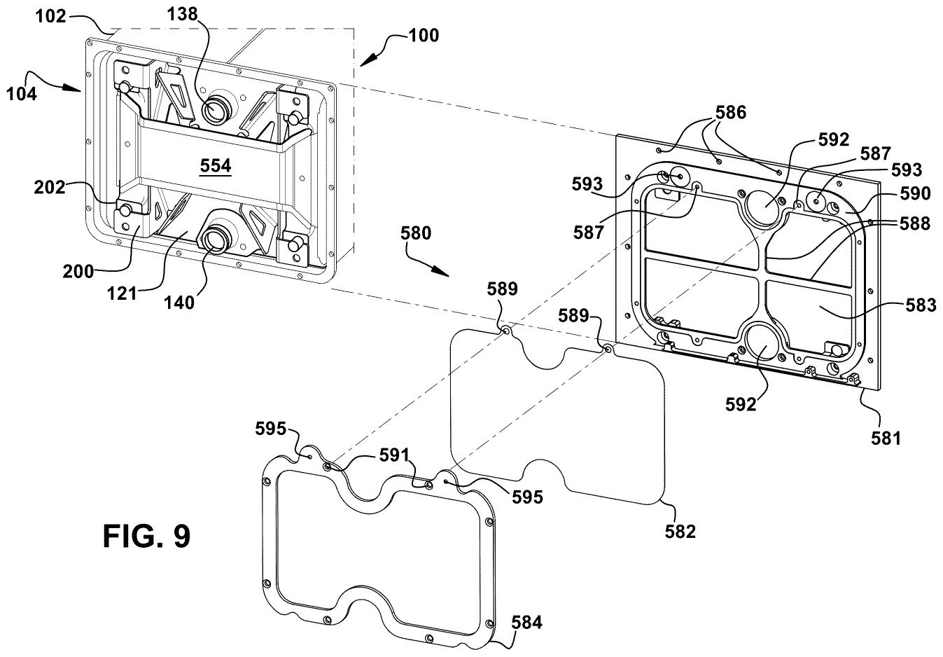

FIG. 9 shows a view of front end 104 of subpack enclosure 102 of battery subpack 100 with front end wall 108 (FIG. 1) removed, as well as an exploded view of burst plate assembly 580, which is included in front end wall 108 (FIG. 1). As shown, busbar 554 crosses front end 104 and covers a vent clearing bracket 200. Vent clearing bracket 200 is attached to bracket mounts 202 and hold cell retainer 121 in place. This action of vent clearing bracket 200 continues during a thermal runaway event to prevent cells 120 (FIG. 3) from moving toward front end wall 104 (FIG. 1), such as from the action of depressurization.

As seen in FIG. 9, burst plate assembly 580 includes a support plate 581 against which burst plate 582 is retained by a capture plate 584, which can also be referred to as a capture gasket or a burst plate gasket. In embodiments, with additional reference to FIG. 1, support plate 581 can be attached to front end 104 of subpack enclosure 102, such as with screws (not shown) through first mounting holes 586. A central opening 583 of support plate 581 is sized to be smaller than front end 104 (FIG. 1) of subpack enclosure 102. Spars 588 can extend across central opening 583 such that burst plate 582 will engage spars 588 when installed. Thus, spars 588 can inhibit or prevent burst plate 582 from entering subpack enclosure 102 in certain circumstances, such as if external pressure exceeds pressure within subpack enclosure 102. In embodiments, a seat 590 can be interposed between burst plate 582 and support plate 581 and can take the form of a seal if suitable and/or desired. Seat 590 can be integrated into support plate 581 and/or can be a separate component held thereon by burst plate 582 and capture plate 584. Support plate 581 includes coolant holes 592 through which fluid connectors 138, 140 (FIG. 1) of battery subpack 100 (FIG. 1) can extend. With support plate 581 attached to subpack enclosure 102 (FIG. 1) and burst plate 582 retained against support plate 581 by capture plate 584, burst plate assembly 580 can form front end wall 108 (FIG. 1) of embodiments. Support plate 581 can include burst assembly mounting holes 586, which can be used to attach burst plate assembly 580 to subpack enclosure 102 (FIG. 1). Support plate 581 can also include plate mounts 587 into which bolts or screws or the like can be screwed after insertion through corresponding plate holes 589 and capture plate holes 591 to retain capture plate 584 and burst plate 582 against support plate 581. For additional retention of burst plate assembly 580 on subpack enclosure 102, support plate 581 can include supplemental mounts 593 to receive screws or bolts or the like inserted through corresponding supplemental holes 595 of capture plate 584.

As suggested above, burst plate 582 is sized and made from a material such that when pressure within subpack enclosure (FIG. 1) exceeds a threshold, burst plate 582 yields and opens subpack enclosure 102 at front end 104 thereof. In embodiments, the combination of thickness, material selection, and size of opening 583 results in burst plate 582 deflecting away from subpack enclosure 102, such as by edges of burst plate 582 lifting away from support plate 581. In embodiments, burst plate 582 and/or capture plate 584 can include an intumescent material so that one or both parts expand when heated. Size and material of capture plate 584 can also be a factor, as can the number, size, strength, and applied torque of any bolts, screws, or the like, used in burst plate assembly 580. Embodiments can also include weakening burst plate 582, such as by forming grooves, perforations, thin spots, or the like, to fine tune burst pressure or direction of release of ejecta from within subpack enclosure 102.

As was noted above with regard to FIG. 5, with additional reference to FIGS. 1-4 and 7, a respective current collector 550 covers each cell group 122, 124 and is separated from an innermost layer of first side wall 116 by a vent gap 174 (FIG. 7) of size V. More particularly, current collector 550 is disposed between vent sides 123, 125 of cell groups 122, 124 and a corresponding wall of subpack enclosure 102, such as first side wall 116 (FIG. 1) or second side wall 118 (FIG. 1). As seen in FIG. 5, each current collector 550 is in electrical communication with cell electrodes 150, 152 of a cell group 122, 124 via a respective collector layer 552, which includes conductive material. Collector layer 552 is in electrical communication with a respective subpack electrical terminal 556 formed in back end 106 (FIG. 2) of subpack enclosure 102 (FIG. 2). In embodiments, respective connectors 558 can place collector layer 552 in electrical communication with subpack electrical terminals 556.

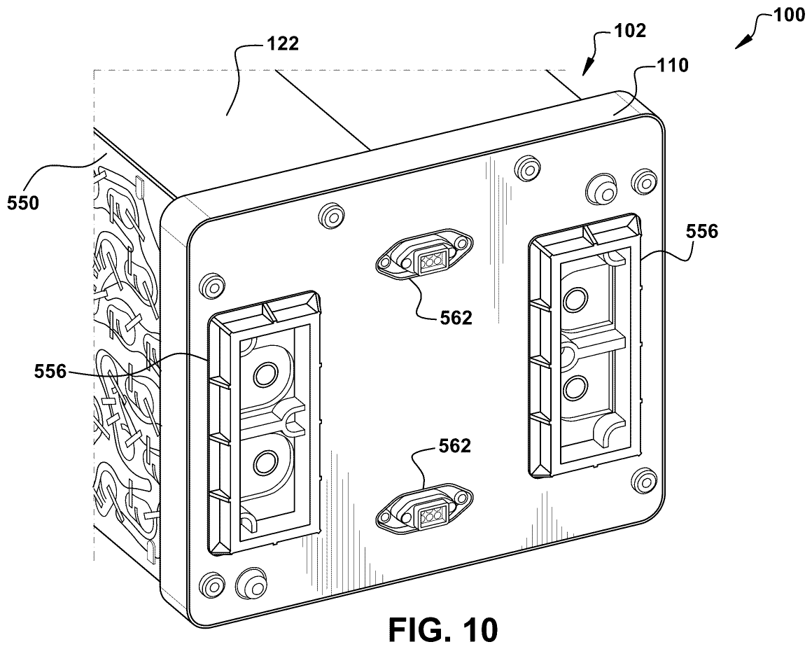

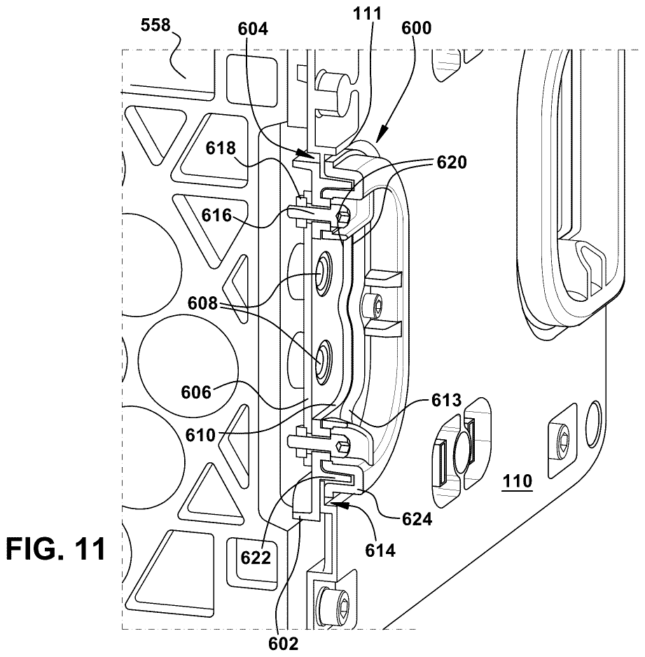

Turning now to FIG. 10, to enable power and data to be transferred from the interior of subpack enclosure 102 to an exterior thereof, embodiments can include subpack electrical terminals 556 and data passthroughs 562 that extend through a wall of subpack enclosure 102, such as back end wall 110. Recalling FIG. 5, current collector 550 includes a respective connector 558 placing conductive layer 552 in electrical communication with subpack electrical terminal 556. As seen in the closeup view of FIG. 11, subpack electrical terminals 556 (FIGS. 5 and 10) can include a terminal assembly 600 of parts inside and outside of subpack enclosure 102, such as on either side of back end wall 110 and/or in a terminal cutout 111 formed therein. Terminal assembly 600 can include a back plate 602 on an inner surface 604 of back end wall 110, and a terminal connector 606 extending from back plate 602 toward cell group 122 (FIG. 5) and in electrical communication with conductive layer 552 (FIG. 5) of current collector 550 (FIG. 5), such as via connector 558. Terminal connector 606 includes one or more holes 608 shaped and sized to receive posts of a connector cable (not shown) of a battery pack (not shown), and back plate 602 includes one or more openings 610 therethrough to allow passage of such posts.

As further seen in FIG. 11, a front plate 612 on an outer surface 614 of back end wall 110 is secured to back end wall 110 and/or back plate 602 and/or terminal connector 606 by bolts 616 extending therethrough with nuts 618 thereon. While bolts 616 are shown, it should be readily apparent that any suitable connector could be employed, such as screws, rivets, and/or brads. Alternatively, front plate 612, back plate 602, and terminal connector 606 can be secured to one or more of each other and/or back end wall 110 by adhesive, welding, or any other suitable connection technique. In embodiments, back plate 602 and/or front plate 612 can be formed from a ceramic material or other suitable material able to withstand conditions extant during thermal runaway of one or more cells within subpack enclosure 102.

Like back plate 602, front plate 612 includes one or more openings 613 to allow connection to terminal connector 606. Neither openings 610 of back plate 602 nor openings 613 of front plate 612 need be shaped or sized to correspond to holes 608 of terminal connector 606, though such can be done if desired and/or appropriate. In embodiments, as shown in FIG. 9, back plate 602 can include one opening 610 and front plate 612 can include one opening 613, and openings 610, 613 of back and front plates 602, 612 can be shaped to correspond to each other and/or to cooperate to mechanically retain a cable connector (not shown) and/or to form a seal therewith.

To seal terminal assembly 600 and maintain subpack enclosure 102 as a pressure vessel, one or more gaskets 620 can be placed between parts of terminal assembly 600. For example, a gasket 620 can be placed between terminal connector 606 and back plate 602 and/or between back plate 602 and front plate 612. To ensure gasket(s) 620 can function in the conditions extant during thermal runaway of one or more cells in subpack enclosure 102, gasket(s) 620 can be made from mica or another suitable material that can withstand the temperatures and/or pressures extant inside subpack enclosure 102 during thermal runaway of one or more cells of battery subpack 100. In addition to gaskets 620, features can be included in back plate 602 and front plate 612 to seal subpack enclosure 102. As seen in FIG. 9, for example, back plate 602 can include a projection 622 that extends into a corresponding recess 624 of front plate 612 so that mating surfaces thereof act as seals. It should be understood that the embodiment shown in FIG. 9 is nonlimiting, and projection 622 could instead be formed on front plate 612 with corresponding recess 624 on back plate 602, or another mating configuration could be employed as may be desired and/or appropriate.

As seen in FIG. 10, a data passthrough assembly 700 can extend through a data cutout 702 in back end wall 110. A circuit board 704 is disposed at an inner surface of back end wall 110 and can be held in position by parts of battery subpack 100 within subpack enclosure 102. Circuit board 704 can include receptacles 706 that can receive pins 708 of a data connector 710. In embodiments, a base 712 of data connector 710 is disposed in data cutout 702 and pins 708 extend toward circuit board 704 and into receptacles 706 from base 712. A body 714 of data connector 710 extends away from data cutout 702 and circuit board 704 and includes conductors 716 and features 718 sized and shaped to correspond to a data cable connector (not shown). A data gasket 720 can be placed between circuit board 704 and back end wall 110 to seal data cutout 702. In embodiments, back end wall 110 can include additional features 722 to facilitate connection and/or retention of a data cable connector (not shown). In embodiments, circuit board 704, pins 708, data connector 710, and gasket 720 are formed from materials selected to withstand temperatures and/or pressures associated with thermal runaway of one or more cells within subpack enclosure 102. For example, circuit board 704 can be formed from a flame retardant glass-reinforced epoxy laminate material. Particularly within the subpack enclosure, the material of circuit board 704 has a National Electrical Manufacturers Association (“NEMA”) grade of at least FR-4. Such material is generally referred to in the art simply as “FR-4” or “FR4,” where “FR” stands for “flame retardant.” As is known, NEMA sets standards for various materials and components. FR-4 is a composite material composed of, for example, woven fiberglass cloth with an epoxy resin binder that is flame resistant. In addition, pins 708 can be formed from copper, data connector 710 can include ceramic materials and copper, and data gasket 720 can include mica.

Embodiments of the disclosure provide various technical and commercial advantages, examples of which are discussed herein. For example, a technical effect resulting from implementing a battery subpack as disclosed herein is to form the subpack enclosure as a pressure vessel to at least partially contain heat, gas, and other products of thermal runaway of one or more cells within the subpack enclosure. A burst plate ruptures when one or more parameters in the subpack enclosure exceed a threshold. When the burst plate ruptures, it acts as a vent through which ejecta, such as hot gas, liquid, particles, and other debris, exit the front end of the subpack enclosure. This limited containment of thermal runaway products takes advantage of thermal gradients to direct the ejecta out the front end of the subpack enclosure while protecting power and data passthroughs at an opposite, “high voltage” end of the subpack enclosure. The electrical and data passthroughs include components that maintain the seal of the subpack enclosure while enabling access to electricity and data from within the subpack enclosure.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of such technology and to enable others of ordinary skill in the art to understand the various embodiments of the present disclosure and the possibility of various modifications of the disclosed embodiments, as may be suited to the particular use(s) contemplated.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A battery subpack comprising:
a subpack enclosure including a front end and a back end opposite the front end, wherein the subpack enclosure is sealed as a pressure vessel and the front end includes a burst plate configured to rupture when a parameter of an interior of the subpack enclosure exceeds a threshold; and
a cell group including a front end, a back end, and a vent side, wherein the cell group is disposed in the subpack enclosure with the respective front ends and back ends of the cell group and the subpack enclosure proximate to each other.

2. The battery subpack of claim 1, wherein at least one wall of the subpack enclosure includes an outer layer of a metallic material and at least one of a layer of thermal insulation, a flame liner, a layer of electrical insulation, a crush layer, and a blast ablative layer between the outer layer and the cell group.

3. The battery subpack of claim 1, wherein a vent gap is defined by the vent side of the cell group and a first side wall of the subpack enclosure, and wherein respective bases of cells of the cell group are mounted on a surface of a heat exchange device with respective vent ends of the cells directed at the first side wall of the subpack enclosure such that ejecta from one of the cells enters the vent gap during a thermal runaway event.

4. The battery subpack of claim 3, wherein the cell group includes a current collector between the vent ends of the cells and the first side wall of the subpack enclosure, and wherein the current collector defines a respective hole aligned with each respective vent end of the cells.

5. The battery subpack of claim 3, wherein the vent gap is in fluid communication with a headspace defined between a top of the cell group and a top wall of the subpack enclosure, wherein the vent gap is positioned to direct ejecta from the cell group to the headspace during the thermal runaway event, and wherein the headspace is in fluid communication with the burst plate.

6. The battery subpack of claim 1, wherein a vent clearing bracket engages and retains the front end of the cell group in position.

7. The battery subpack of claim 1, wherein a front end wall of the subpack enclosure includes an opening therethrough and a spar extending across the opening, the burst plate engages an outer side of the spar, and a capture plate engages an outer surface of the burst plate to retain the burst plate against the spar, thereby sealing the subpack enclosure.

8. A subpack electrical terminal assembly for the battery subpack of claim 1, comprising:
a back plate on an inner surface of a back end wall of the subpack enclosure;
a terminal connector extending from the back plate toward the cell group and in electrical communication with a conductive layer of a current collector of the battery subpack, wherein the terminal connector defines a hole shaped and sized to receive a post of a connector cable, and wherein the back plate includes an opening therethrough to allow passage of such posts; and
a front plate on an outer surface of the back end wall and secured to at least one of the back end wall, the back plate, or the terminal connector by bolts extending therethrough with nuts thereon.

9. The subpack electrical terminal assembly of claim 8, wherein the front plate has an opening formed therein to allow connection to the terminal connector.

10. The subpack electrical terminal assembly of claim 8, wherein one of the back plate or the front plate includes a projection and the other of the back plate or the front plate includes a recess corresponding to the projection, wherein the projection and recess mate and form a seal.

11. The subpack electrical terminal assembly of claim 8, further comprising a gasket.

12. The subpack electrical terminal assembly of claim 11, wherein the gasket is formed from a material including mica.

13. The subpack electrical terminal assembly of claim 11, wherein the gasket is between the terminal connector and the back plate.

14. The subpack electrical terminal assembly of claim 11, wherein the gasket is between the back plate and the front plate.

15. A data passthrough assembly for the battery subpack of claim 8, comprising:
a data cutout formed through a back end wall of the subpack enclosure;
a circuit board disposed at an inner surface of the back end wall, wherein the circuit board is held in position by the current collector and includes receptacles; and
a data connector including a base disposed in the data cutout, wherein the base includes pins that extend from the base toward the circuit board and into the receptacles, wherein the data connector further includes a body that extends away from the data cutout and includes conductors and features sized and shaped to correspond to a data cable connector.

16. The data passthrough assembly of claim 15, further comprising a data gasket between the circuit board and the back end wall.

17. The data passthrough assembly of claim 16, wherein the data gasket includes mica.

18. The data passthrough assembly of claim 15, wherein at least one of the data connector or the pins include copper.

19. The data passthrough assembly of claim 15, wherein the data connector includes an additional material inboard of the pins.

20. The data passthrough assembly of claim 19, wherein the additional material includes silicone.
